(19) United States
(12) Patent Application Publication
(10) Pub. No.: US 2025/0092273 A1
(43) Pub. Date: Mar. 20, 2025

(54) WAX-BASED DRY ERASE INK

(71) Applicant: Crayola LLC, Easton, PA (US)

(72) Inventor: Regan Johnson, Fleetwood, PA (US)

(73) Assignee: Crayola LLC, Easton, PA (US)

(21) Appl. No.: 18/816,313

(22) Filed: Aug. 27, 2024

Related U.S. Application Data
(60) Provisional application No. 63/538,575, filed on Sep. 15, 2023.

(51) Int. Cl. C09D 11/16; B43K 8/02

(52) U.S. Cl. CPC C09D 11/16; B43K 8/024

(57) ABSTRACT

Disclosed herein are a water and wax-based ink, a marking instrument comprising the water and wax-based ink, and a kit comprising the marking instrument and a marking element comprising a non-porous surface, wherein a mark applied on the non-porous surface using the marking instrument is substantially removable without application of any solvent. The water and wax-based ink composition comprises an opacifying waxy material, a dispersant, water, and optionally a dye.

### FIELD OF THE INVENTION

The present invention relates to water and wax-based ink compositions, marking instruments comprising the same, and kits comprising the marking instrument and a marking element comprising a non-porous surface.

### BACKGROUND OF THE INVENTION

Whiteboards, also known as dry erase boards, are commonly used in offices, schools, and other locations where a chalkboard might otherwise be found. Markings on a dry erase board are erasable by wiping lightly with felt, a dry cloth or paper. Suitable whiteboard surfaces generally include a melamine, vinyl, polyethylene laminate, or enamel resin layer affixed to a backing. Such whiteboards are characterized in that they have hard, colored surfaces, generally white, that are very smooth in appearance, and are essentially nonporous. Alternatively, a whiteboard may comprise a glass surface or a sheet of polymeric film such as an acrylic or UV curable resin.

A variety of compositions are known for use in writing on impervious writing surfaces such as whiteboards. These coloring compositions suitable for use on whiteboards must erase easily without requiring comprehensive cleaning, Additionally, the whiteboard compositions must be removable without leaving visible remains commonly termed “ghosting,”

Whiteboard coloring compositions suffer from a variety of well-known deficiencies. Most whiteboard markers are alcohol-based which may be toxic and/or flammable and, thus, are not appropriate for use by young children. Further, many whiteboard markers produce writings which are not readily erasable from whiteboards after the passage of a significant period of time. Finally, current whiteboard markers have a propensity to leave enduring stains on clothing. While permanence is a desirable characteristic of the so-called “permanent” markers, it is one of the most objectionable properties for coloring instruments used by young children.

No known dry erase or marker ink exists that dry erases with wax dispersions but there are wax-based printing inks available. They come in water-based, solvent-based, solid and UV cure form. Wax printing inks are designed to be rub/friction resistant and do not target erasability since they are designed for paper, not nonporous surfaces,

It is therefore one general object of the present invention to provide a dry erase ink composition for use on whiteboards and other non-porous surfaces which is also washable from the skin and clothes.

### SUMMARY OF THE INVENTION

Disclosed herein is a water and wax-based ink composition comprising an opacifying waxy material, a dispersant, and water. In an embodiment of the water and wax-based ink composition, the opacifying waxy material comprises one or more of carnauba wax, beeswax, lanolin, tallow tree wax, laurel wax, bayberry wax, candelilla wax, ouricury wax, castor wax, Chinese wax, Japan wax, sugarcane wax, soy wax, paraffin waxes, microcrystalline waxes, synthetic waxes, polyethylene wax, montan wax, ceresin, ozocerite, monoglycerides, diglycerides, triglycerides, and esters of fatty alcohols and fatty acids having 12-40 carbon atoms. In some embodiments, the opacifying waxy material is carnauba wax. In other embodiments, the opacifying waxy material is a diester of alkylene glycol having 2-20 carbon atoms and a fatty acid comprising stearic acid, lauric acid, myristic acid, palmitic acid, arachidic acid, behenic acid, lignoceric acid, and cerotic acid.

In an embodiment, the water and wax-based ink composition further comprises a colorant. In some embodiments, the colorant is a water-soluble dye. The water-soluble dye may comprise an acid dye, a basic dye, a polymeric colorant, a fluorescent dye, a solvent dye, a disperse dye, a direct dye, a reactive dye, and an FD&C dye. In other embodiments, the colorant is a pigment.

In another embodiment of the water and wax-based ink composition, the dispersant comprises one or more of alkylbenzene sulfonates, polyoxyethylene alkyl ethers, acetylenic diols, ethoxylated acetylenic diols, sultains, betaines, amine oxides, ethoxylated alcohols, nonylphenol ethoxylates, and cationic and anionic polymers.

In some embodiments, the water and wax-based ink composition further comprises one or more of a humectant, a surfactant, a preservative, a defoamer, and/or a pH regulant.

In one embodiment, the water and wax-based ink composition comprises 5-50% by mass of the opacifying waxy material, wherein the opacifying waxy material comprises at least one of carnauba wax and ethylene glycol distearate; 10-40% by mass of water; an effective amount of dispersant; and 0 to 15% of a water-soluble dye.

In an aspect, there is a marking instrument comprising the water and wax-based ink composition as disclosed hereinabove. In an embodiment, the marking instrument is an erasable marker comprising a marker barrel and a writing tip, wherein the water and wax-based ink composition is disposed in the marker barrel. In another embodiment, the erasable marker is a dry-erase marker.

In another aspect, there is a kit comprising a marking element comprising a non-porous surface and a marking instrument as disclosed hereinabove, wherein a mark applied on the non-porous surface using the marking instrument is substantially removable without application of any solvent. In an embodiment of the kit, the non-porous surface comprises a blackboard, whiteboard, a greenboard, a glass surface, a writing slate, a natural stone, a plastic surface, a coated surface, a metal surface, or a laminated surface. In one embodiment, the kit further comprises an erasing tool. In another embodiment, the erasing tool comprises a fabric cloth, a microfiber cloth, a felt eraser, a synthetic fiber eraser, or a sponge.

### BRIEF DESCRIPTION OF THE DRAWINGS

FIGS. 1A and 1B show markings, on a gray plastic surface, of a water and wax-based ink according to an embodiment of the present invention.

FIG. 2 show markings, on a black plastic surface, of a water and wax-based ink according to an embodiment of the present invention.

FIG. 3 show markings, on a green plastic surface, of a water and wax-based ink according to an embodiment of the present invention.

FIGS. 4A and 4B show, a fabric before and after washing, with markings of a water and wax-based ink, according to an embodiment of the present invention.

### DETAILED DESCRIPTION OF THE INVENTION

The subject matter of embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

As used herein, the term “opacifying material” refers to any material that can reduce or even prevent the transmittance of visible light through itself or through a composition comprising such opacifying material. Opacifying materials not only prevent light transmission, but may also provide ideal brightness and whiteness to the composition comprising the same.

As used herein, the term “waxy material” refers to any material with sufficient hardness to be handled, yet soft enough that abrasion of the material at reasonable pressure against a substrate such as paper will result in the material adhering to the substrate. Certain waxy materials disclosed herein have a melting point in the range of 40° C. to 100° C.

As used herein the term “water and wax-based ink composition” is used interchangeably with “water and wax-based ink,” “wax-based ink composition,” “wax-based ink,” “wax-based dry erase ink,” “dry erase ink,” and “ink composition.”

The present invention provides water and wax-based ink compositions and marking instrument comprising the same. In an aspect, the water and wax-based ink composition comprises an opacifying waxy material, a dispersant, water, and optionally a colorant.

### Opacifying Waxy Material

Any suitable opacifying waxy material may be used, including, but not limited to, one or more of carnauba wax, beeswax, lanolin, tallow tree wax, laurel wax, bayberry wax, candelilla wax, ouricury wax, castor wax, Chinese wax, Japan wax, sugarcane wax, soy wax, paraffin waxes, microcrystalline waxes, synthetic waxes, polyethylene wax, montan wax, ceresin, ozocerite, monoglycerides, diglycerides, triglycerides, and esters of fatty alcohols and fatty acids having 12-40 carbon atoms. In some embodiments, the fatty esters have more than 40 carbon atoms. In an embodiment, the fatty ester is linear. In another embodiment, the fatty ester is branched due to the fatty alcohol and/or the fatty acid being branched.

### Fatty Acids

Any suitable fatty acid including saturated or unsaturated, linear or branched fatty acids may be used.

### Saturated Fatty Acids

Suitable saturated fatty acids include, but are not limited to, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, carboceric acid, montanic acid, noncosylic acid, melissic acid, hentriacontylic acid, lacceroic acid, psyllic acid, geddic acid, ceroplastic acid, hexatriacontylic acid, heptatriacontylic acid, octatriacontylic acid, nonatriacontylic acid, and tetracontylic acid.

### Unsaturated Fatty Acids

Suitable unsaturated fatty acids include, but are not limited to, α-linolenic acid, stearidonic acid, eicosapentaenoic acid, cervonic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid, mead acid, myristoleic acid, sapienic acid, gadoleic acid, eicosenoic acid, eicosadienoic acid, docosadienoic acid, pinolenic acid, eleostearic acid, eicosatrienoic acid, stearidonic acid, eicosatetraenoic acid, adrenic acid, bosseopentaenoic acid, eicosapentaenoic acid, ozubondo acid, clupanodonic acid, and nisinic acid.

### Fatty Alcohols

Any suitable fatty alcohol may be used. The fatty alcohols may be saturated or unsaturated. The fatty alcohols may also be linear or branched. Example of fatty alcohols include but are not limited to, lauryl alcohol, tridecyl alcohol, myristyl alcohol, pentadecyl alcohol, cetyl alcohol, palmitoleyl alcohol, heptadecyl alcohol, stearyl alcohol, oleyl alcohol, nonadecyl alcohol, arachidyl alcohol, heneicosyl alcohol, behenyl alcohol, erucyl alcohol, lignoceryl alcohol, ceryl alcohol, 1-heptacosanol, montanyl alcohol, 1-nonacosanol, myricyl alcohol, lacceryl alcohol, geddyl alcohol.

Any suitable fatty ester may be used. In one embodiment, fatty ester comprises at least one of the fatty alcohol and/or the fatty acid as disclosed herein above. Suitable examples of fatty esters include, but are not limited to, glyceryl monostearate, ethylene glycol distearate, hexadecyl stearate, butyl stearate, isobutyl stearate, isopropyl lanolate, isopropyl palmitate, isopropyl myristate, butyl myristate, cetyl myristate, decyl oleate, cetyl ricinoleate, isocetyl lanolate, isopropyl adipate, and hexyl laurate.

In an embodiment of the water and wax-based ink compositions, the opacifying waxy material is carnauba wax. In another embodiment, the opacifying waxy material is a diester of an alkylene glycol having 2-20 carbon atoms and a fatty acid comprising stearic acid, lauric acid, myristic acid, palmitic acid, arachidic acid, behenic acid, lignoceric acid, and cerotic acid. The opacifying waxy material can be present in the water and wax-based ink composition in an amount from 3% to 60%, or 3% to 50%, or 4% to 40%, or 5% to 20% by weight of the water and wax-based ink composition.

In an embodiment, the opacifying waxy material is white in color without any added additional colorant. In some embodiments, the water and wax-based ink including the opacifying waxy material and without any added colorant is suitable for leaving a visible mark on any non-white surface, i.e., a darker colored surface.

In another embodiment, the water and wax-based ink composition further includes a water-soluble dye as a colorant. Any suitable water-soluble dye may be used, including, but not limited to an acid dye, a basic dye, a polymeric dye, a fluorescent dye, a solvent dye, a disperse dye, a direct dye, a reactive dye, and an FD&C dye. The water-soluble dye may be present in an amount of 0 to 10%, or 0.01% to 5%, or 0.01% to 3% by weight of the water and wax-based ink composition.

### Acidic Dyes

The terms “acid dye” or “acidic dye” are recognized in the art and are intended to include those water-soluble anionic dyes that are applied to a material from neutral to acid solution. Attachment to the material is attributed, at least partly, to salt formation between anionic groups in the dyes and cationic groups in the material. Generally, acid dyes have functional groups such as azo, triaryl methane or anthraquinone that include acid substituents such as nitro, carboxy or sulfonic acid groups.

Representative examples of acid dyes useful in the present compositions include, but are not limited to, Acid Black 1, Acid Black 2, Acid Black 24, Acid Black 48, Acid Blue 1, Acid Blue 7, Acid Blue 9, Acid Blue 25, Acid Blue 29, Acid Blue 40, Acid Blue 45, Acid Blue 74, Acid Blue 80, Acid Blue 83, Acid Blue 90, Acid Blue 92, Acid Blue 113, Acid Blue 120, Acid Blue 129, Acid Blue 147, Acid Green 1, Acid Green 3, Acid Green 5, Acid Green 25, Acid Green 27, Acid Green 50, Acid Orange 6, Acid Orange 7, Acid Orange 8, Acid Orange 10, Acid Orange 12, Acid Orange 51, Acid Orange 51, Acid Orange 63, Acid Orange 74, Acid Red 1, Acid Red 4, Acid Red 8, Acid Red 14, Acid Red 17, Acid Red 18, Acid Red 26, Acid Red 27, Acid Red 29, Acid Red 37, Acid Red 44, Acid Red 50, Acid Red 51, Acid Red 52, Acid Red 66, Acid Red 73, Acid Red 87, Acid Red 88, Acid Red 91, Acid Red 92, Acid Red 94, Acid Red 97, Acid Red 103, Acid Red 114, Acid Red 150, Acid Red 151, Acid Red 183, Acid Violet 7, Acid Violet 9, Acid Violet 17, Acid Violet 19, Acid Yellow 1, Acid Yellow 3, Acid Yellow 9, Acid Yellow 11, Acid Yellow 17, Acid Yellow 23, Acid Yellow 25, Acid Yellow 29, Acid Yellow 34, Acid Yellow 36, Acid Yellow 42, Acid Yellow 54, Acid Yellow 73, Acid Yellow 76 and Acid Yellow 99.

### Basic Dyes

The terms “base dye” or “basic dye” are recognized in the art and are intended to include those water-soluble cationic dyes that are applied to a material from neutral to basic solution. Generally, basic dyes have functional groups such as sulfonium, oxonium, or quaternary ammonium functional groups. Attachment to the material is attributed, at least partly, to salt formation between cationic groups in the dyes and anionic groups in the material.

Representative examples of basic dyes useful in the present compositions include, but are not limited to, Basic Black 2, Basic Blue 3, Basic Blue 6, Basic Blue 7, Basic Blue 9, Basic Blue 11, Basic Blue 12, Basic Blue 16, Basic Blue 17, Basic Blue 24, Basic Blue 26, Basic Blue 41, Basic Blue 66, Basic Blue 140, Basic Brown 1, Basic Brown 4, Basic fuchsin, Basic Green 1, Basic Green 4, Basic Green 5, Basic Orange 2, Basic Orange 14, Basic Orange 21, Basic Red 1, Basic Red 2, Basic Red 5, Basic Red 9, Basic Red 29, Basic Violet 1, Basic Violet 2, Basic Violet 3, Basic Violet 4, Basic Violet 10, Basic Yellow 1, Basic Yellow 2, and Basic Yellow 49.

### Polymeric Colorants

The term “polymeric colorant” is recognized in the art and polymeric colorants are a group of intermediate or high molar mass compounds that are intrinsically colored. The polymeric colorants of the present invention are water soluble. The polymeric portion of the polymeric colorant is a water-soluble polymer. Polymeric dyes may be defined through their applications as polymers and dyes, which possess suitably high tinctorial strength. Polymeric dyes are characterized by having polymeric chains covalently bonded to a chromophore (dye) molecule.

Representative examples of polymeric dyes useful in compositions of the invention include, but are not limited to, Palmer Orange, Palmer Blue, Palmer Magenta, Palmer Fluorescent Red, Palmer Yellow R, Palmer Scarlett, Palmer Black, Palmer Patent Blue, LiquiTone Magenta 418, Polytint Violet X80LT, Polytint Orange X96, Polytint Yellow X15, Polytint Black X41LV, Polytint Red X64, Polytint Blue X3LV, & mixtures thereof, manufactured by Milliken & Co., Spartanburg, S.C.

### Fluorescent Dyes

The term “fluorescent dye” is recognized in the art and is intended to include those dyes which give fluorescence either in solid phase or in liquid form. The color of compound can be different from the fluorescence in liquid form.

Representative examples of fluorescent dyes/pigments useful in the present compositions include, but are not limited to, fluorescein, fluorescein diacetate, carboxyfluorescein, carboxyfluorescein diacetate, rhodamine B, sulforhodamine B, cotadecyl rhodamine B, rhodamine 6G, rhodamine 110, rhodamine 123, xanthene dyes, thioxanthene dyes, naphtholactam dyes, azlactone dyes, methane dyes, oxazine dyes, thiazine dyes, fluorol, coumarin, 7-N,N-dialkylamino-3-hetarylcoumarin dyes, resorufin, quinoxalines, pyrido[1,2-a]benzimidazoles, acridine, acriflavin, acridine orange, nonyl acridine orange, xanthene, eosin Y, pyronine Y, Texas red, calcein, quinacrine, ethidium bromide, propidium iodide, resazurin, nile blue, crystal violet, DiO6 (3), JC-1, YOYO-1, DAPI, Hoechst 33342, FM 1-43, thiazole orange, primuline, thioflavin T, calcein blue, morin, naphthol blue black, fura-2,4-amino-3-sulfo-1,8-naphthalimide, naphthalimide dyes, and their derivatives.

### Fluorescent Pigments

Although, fluorescent pigments are not water-soluble, they can be used as fluorescent pigment dispersions in some embodiments of the present invention.

### Solvent Dyes

The term “solvent dye” is recognized in the art, with solubility in an organic solvent or solvents being a characteristic physical property of the solvent dye.

Representative examples of solvent dyes useful in the present compositions include, but are not limited to, Solvent Black 3, Solvent Black 5, Solvent Blue 14, Solvent Blue 35, Solvent Blue 38, Solvent Blue 43, Solvent Blue 59, Solvent Brown 1, Solvent Green 1, Solvent Green 3, Solvent Green 7, Solvent Green 11, Solvent Orange 1, Solvent Orange 2, Solvent Orange 7, Solvent Orange 15, Solvent Red 19, Solvent Red 23, Solvent Red 24, Solvent Red 26, Solvent Red 27, Solvent Red 41, Solvent Red 43, Solvent Red 45, Solvent Red 49, Solvent Red 72, Solvent Violet 8, Solvent Yellow 2, Solvent Yellow 3, Solvent Yellow 7, Solvent Yellow 14, Solvent Yellow 33, Solvent Yellow 94, manufactured by Sigma-Aldrich, St. Louis, Mo.; and Special Fluorescent Yellow 3G (Solvent Green 7), manufactured by Lanxess Corporation, Pittsburgh, Pa.

### Disperse Dyes

The term “disperse dye” is recognized in the art and is intended to include non-ionic dyes with partial water solubility.

Representative examples of disperse dyes useful in the present compositions include, but are not limited to, Disperse Orange 1, Disperse Orange 3, Disperse Blue 3, Disperse Violet 1, Disperse Violet 4, Disperse Red 9, Disperse Red 11, Disperse Red 60, Disperse Yellow 26, Disperse Yellow 42, and Disperse Black 9.

### Direct Dyes

The term “direct dye” is recognized in the art and is intended to include those water-soluble dyes that adsorb onto a material. Bonding is believed to occur through hydrogen bonding and/or Van der Waals forces between the dye and the substrate.

Representative examples of direct dyes useful in the present compositions include, but are not limited to, Direct Blue 1, Direct Blue 14, Direct Blue 53, Direct Blue 71, Direct Red 2, Direct Red 23, Direct Red 28, Direct Red 75, Direct Red 80, Direct Red 81, Direct Violet 51, Direct Yellow 4, Direct Yellow 7, Direct Yellow 8, Direct Yellow 9, Direct Yellow 12, Direct Yellow 27, Direct Yellow 50, Direct Yellow 59, and Direct Yellow 62.

### Reactive Dyes

The term “reactive dye” is recognized in the art and is intended to include those dyes that contain a reactive group, for example, either a haloheterocycle or an activated double bond, that, when applied to a surface in a weakly alkaline solution, forms a chemical bond with a hydroxyl or amino group on the substrate.

Representative examples of reactive dye compounds useful in the present compositions include, but are not limited to, Procion red, blue, orange and yellow (ICD), Levafix E Yellow (Bayer), Remazol Yellow (Hoechst), Cibacron (Ciba), Drimarene X, R, K (Sandoz), Scarlet MX-BRA, Yellow MX-3RA, Brilliant Yellow MX-8G, Green MX-700, Royal Blue MX-G1, Red MX-8B, Black MX-A, Purple MX-ADS, Violet MX BPS2, Orange MX-2R, Turquoise MX-G and Blue MX-R (all from Organic Dyes and Pigments), Reactive Black 5, Reactive Blue 2, Reactive Blue 4, Reactive Blue 13, Reactive Blue 109, Reactive Blue 140, Reactive Orange 4, Reactive Orange 16, Reactive Orange 86, Reactive Yellow 4, and Reactive Yellow 86.

### “FD&C” and “D&C” Dyes

The terms “FD&C” and “D&C” dyes are recognized in the art. In the United States, colorants for food, drugs and cosmetics are regarded as “color additives”. The Federal Food, Drug & Cosmetic (FD&C) Act of 1938 made food color additive certification mandatory. Since then the Food and Drug Administration (FDA) has been responsible for regulating all color additives used in food, drugs and cosmetics. Each batch to be sold in the United States has to be certified by the FDA. To avoid confusing color additives used in food with those manufactured for other uses, 3 categories of certifiable color additives were created: 1) FD&C (Food, Drug & Cosmetics) color additives with applications in food, drug & cosmetics 2) D&C (Drug & Cosmetics) color additives with applications in drug & cosmetics 3) External D&C (External Drug & Cosmetics) color additives with applications in externally applied drugs & in externally applied cosmetics. The use of all food colors approved for use in the United States are listed in 21 CFR (Code of Federal Regulation), parts 70 through 82 dealing with color additives.

Representative examples of FD&C dyes useful in compositions of the invention include, but are not limited to FD&C Blue 1, FD&C Blue 2, FD&C Green 3, FD&C Red 3, FD&C Red 40, FD&C Yellow 5, FD&C Yellow 6, Fast Emerald Green, and mixtures thereof, manufactured by Sensient Colors Inc., St. Louis, Mo., Vitasyn Tetrazine X 90, Vitasyn Orange RGL 90, Vitasyn Quinoline Yellow 70, Vitasyn Ponceau 4RC 82, Vitasyn Blue AE 90, Vitasyn Patent Blue V 85 01, Sanolin Flavin 8GZ, Sanolin Yellow BG, Sanolin Red NBG, Sanolin Rhodamine B, Sanolin Violet E2R, Sanolin Violet FBL, Sanolin Blue NBL, Sanolin Blue EHRL, Sanolin Blue EHRL Liquid, and mixtures thereof, manufactured by Clariant Corp., Coventry, RI.

In an embodiment, the water and wax-based ink composition may further comprise a pigment dispersed in water as a colorant. Examples of such suitable pigments include organic pigments such as carbon black, phthalocyanines (e.g., copper phthalocyanine blue), azo pigments, quinacridones, anthraquinones, dioxazines, indigos, thioindigos, perynones, perylenes, indolenones and azo-azomethines. Fluorescent pigments and encapsulated pigments may also be utilized. Other pigments including, for example, inorganic pigments in ultrafine encapsulated or modified form, are likewise suitable for use.

To achieve good coloring and promote compatibility with the remaining components, the pigment may be utilized in the form of an aqueous dispersion, inasmuch as pigments are by definition insoluble materials. Pigment dispersions are commercially available which are combinations of a pigment, an aqueous based carrier, one or more resins, and a surfactant or dispersant system. A pigment dispersion may also be prepared specifically for use in the water and wax-based ink compositions of the present invention. Typical commercial pigment dispersions contain 30 to 74% by weight of active pigment ingredients. Examples of suitable commercially available aqueous pigment dispersions include Sunsperse®, Flexiverse® and Unisperse® product lines from Sun Chemical Corp. (Parsippany, NJ). Aside from these, any pigment may be dispersed in water. Examples of suitable pigments include white pigments, yellow pigments, orange pigments, red pigments, blue pigments, green pigments, violet pigments, and black pigments. Examples of white pigments include titanium dioxide, zinc oxide, or calcium carbonate. Examples of yellow pigments include C.I. Pigment Yellow (13, 14, 42, 74, 93, 95, 109, 110, 120, 128, 138, 139, 151, 154, 155, 173, 180, 185, or 193). Examples of orange pigments include C.I. Pigment Orange (13, 34, 36, 43, 61, 63, or 71). Examples of red pigments include C.I. Pigment Red (22, 48:2, 49:2; 57:1, 81:3, 101, 122 or 202). Examples of blue pigments include C.I. Pigment Blue (1 or 15:3). Examples of green pigments include C.I. Pigment Green (1, 4, 7 or 14). Examples of violet pigments include C.I. Pigment Violet (1, 3, 19, 23, or 33). Examples of black pigments include C.I. Pigment Black (7 or 9).

Pigments may be used in the inventive water and wax-based ink compositions in any amount necessary to give the desired color effect provided that the pigment does not raise the viscosity of the composition to an unacceptable level. The water and wax-based ink composition of the present invention may contain a pigment colorant in an amount of from 0% to 20%, or 0.1 to 10%, or 0.2 to 5% by weight of the water and wax-based ink composition.

### Dispersant

In some embodiments, the water and wax-based ink composition as disclosed hereinabove may include a dispersant. Suitable dispersants include, but are not limited to, alkylbenzene sulfonates, polyoxyethylene alkyl ethers, acetylenic, diols, ethoxylated acetylenic diols, sultains, betaines, amine oxides, ethoxylated alcohols, nonylphenol ethoxylates, and cationic and anionic polymers. Specific examples of polyoxyethylene alkyl ethers include polyoxylethylene-9-lauryl ether, polyoxyethylene-20-stearyl ether, and polyoxyethylene-20-oleyl ether. An example of an acetylenic diol is 2,4,7,9-tetramethyl-5-decyne-4,7-diol. An example of an ethoxylated acetylenic diol is 2,5,8,11-tetramethyl-6-dodecyn-5,8-diol ethoxylate. Specific examples of sultains are lauramidopropyl hydroxysultain and cocamidopropyl hydroxysultain. An example of a betaine is cocamidopropyl betaine. Examples of amine oxides are lauryldimethylamine oxide and myristamine oxide. Dispersants may also be polymeric, for example, copolymers of alkyl (meth)acrylates and styrene or salts of polyacrylic and methacrylic acids. In an embodiment, the dispersant may comprise one or more of cocamidopropyl betaine, sodium laureth sulfate, and polyoxyethylene alkyl ethers.

Dispersants may be used in the inventive water and wax-based ink compositions in an effective amount necessary to disperse opacifying waxy material in water. As used herein, an effective amount of dispersant in the water and wax-based ink composition of the present invention may be in a range of from 0.001% to 20%, or 0.005% to 15%, or 0.01% to 10%, 0.05% to 5%, or 0.1 to 5%, or 0.01 to 3% by weight of the water and wax-based ink composition.

### Optional Additives

In an embodiment of the water and wax-based ink composition according to embodiments of the present invention, the water and wax-based ink composition may further comprise one or more optional additives, such as anti-microbial preservatives, a humectant, a surfactant, a defoamer, and/or a pH regulant. These materials and their functions are well known, and their mention here is by way of illustration only. Generally, any effective amount of the additive may be used so long as the stability of the coloring composition is not adversely affected, and the composition is suitable for use in the desired end product.

### Humectant

For example, it may be possible to include a humectant in the water and wax-based ink compositions to retard the evaporation of water from the ink solution. This avoids unduly rapid drying of the ink in the marker nib which can cause clogging of the nib and impair the function of the marker. Further, a humectant may improve freeze/thaw stability of the inventive ink compositions. Typical humectants include polyhydric alcohols such as glycerin, propylene glycol, ethylene glycol, and diethylene glycol, hydroxylated starches, low molecular weight (m.w.=200-400) poly(ethylene glycols), and mixtures of these materials. Any effective amount of humectant may be used although a generally useful concentration range for these humectants is from 5% up to 30% by weight of the water and wax-based ink composition.

Surfactants in any effective amount (generally up to 0.5% by weight) are also useful in the water and wax-based ink compositions, for the purpose of adjusting such properties as viscosity (for proper dispensing of ink through the nib), and surface tension (for good flow properties and whiteboard wetting). Nonionic surfactants, such as poly (ethylene glycol) ethers, alkylaryl polyether alcohols, fluorinated alkyl esters, and mixtures of such materials are preferred for use in the water and wax-based ink compositions.

### Preservatives

Preservatives of conventional types are also advantageously employed in the water and wax-based ink compositions of the present invention when used as an erasable whiteboard marker ink to extend the shelf life of the composition. The preservative preferably serves as both a bactericide and a fungicide. Some typical preservatives useful in embodiments of the present invention include methyl p-hydroxybenzoate, glutaraldehyde, hydroxybenzoic acid esters, 3-iodo-2-propynyl butyl carbamate, bicyclic oxazolidones, and a biocide comprising as the active ingredients 5-chloro-2-methyl-4-isothiazolin-3-one and, 2-methyl-4-isothiazolin-3-one.

Preservatives are usually effective when present in any effective amount but generally are present in amounts of from 0.1% up to 1% by weight. Preferred preservatives include Nuosept 95™ (bicyclic oxazolidines solutions) manufactured by Huls America, Preventol CMK 40 manufactured by Lanxess, Polyphase AF-1 manufactured by Troy, and Reputain K50 manufactured by Arch Chemicals.

### PH Regulant

The pH of the coloring compositions of the present invention is preferably in the range of 7.0 to 9.0, more preferably 8.0 to 8.5. To maintain this basic pH, a pH regulant may be employed. Preferably, neutralized versene is used as a pH regulant. In addition to controlling pH, neutralized versene may also help ease the erasability of some dyes from whiteboards when compositions of the invention are used as whiteboard marker inks. The pH regulant may be added in an amount ranging from 0% to 20% by weight. In one preferred composition, the pH regulant, neutralized versene, is added in an amount of 10% by weight of the water and wax-based ink composition.

### Defoamer

Additionally, the coloring compositions of the present invention may also contain a defoamer to prevent foaming during mixture of the various components. Suitable defoamers include silicones and siloxanes. The preferred defoamer is Tego Foamex 800™ marketed by Goldschmidt Chemical Corp. Other suitable defoamers include Zerofome AF-200™ marketed by NuTech Corp, Surfynol DF58™ marketed by Air Products, and Foamaster H™ marketed by Henkel. The addition of defoamer to the coloring compositions of the present invention does not adversely affect the removability of these compositions from whiteboards when the compositions are used as whiteboard marker inks. The amount of defoamer depends upon the amounts of other components present in the coloring composition, although typically maybe present in an amount of from 0.1% to 5% by weight of the water and wax-based ink composition.

### Dye Blocker

Any dye blockers readily ascertainable by those skilled in the art may be suitable for use in compositions of the present invention (e.g., those available under the tradenames Milliguard®, Richfix®, or Dow® 2A-1. Dye blockers include, but are not limited to, sodium octane sulfonate, sodium xylene sulfonate, fatty alcohol ethoxylates, disodium hexadecyldiphenyloxide disulfonate, benzene-1,1-oxybis-tetrapropylene sulfonated sodium, decyl-sulfophenoxybenzenesulfonic acid-disodium, decyl-sulfophenoxybenzenesulfonic acid disodium, octylphenoxypolyethoxyethanol, sodium salt of naphthalene-formaldehyde condensate, sodium salt of carboxylated polyelectrolytes, sodium lignin sulfonate, and polyethoxylated tert-dodecyl sulfur compounds. According to particular embodiments, one or more dye blockers are present in amounts ranging from 1% to 20% by weight.

### Water and Wax-Based Ink

In an embodiment, the water and wax-based ink composition of the present invention may comprise 5-50% by mass of the opacifying waxy material, wherein the opacifying waxy material comprises at least one of carnauba wax and ethylene glycol distearate; 10-40% by mass of water; an effective amount of dispersant; and 0 to 15% of a water-soluble dye or pigment dispersion,

The water and wax-based ink compositions according to various embodiments of the present invention exhibits favorable dry erase characteristics and lacks ghosting on most whiteboards. The fugitivity of this whiteboard marker ink from skin and fabric is also excellent.

### Marking Instrument

In an aspect, there is a marking instrument comprising the water and wax-based ink composition as disclosed hereinabove. The marking instrument may use any conventional marker. In an embodiment, the marking instrument is an erasable marker comprising a marker barrel and a writing tip, wherein the water and wax-based ink composition is disposed in the marker barrel. Any suitable writing tip may be used. The marker barrel containing the water and wax-based ink can be any standard marker delivery system including, but not limited to, acetate, polyester, or polypropylene fiber systems or a fiberless system. In an embodiment, the marking instrument is a dry-erase marker and the writing tip is a felt tip.

### Kit

In another aspect, there is a kit comprising the marking instrument as disclosed hereinabove, and a marking element comprising a non-porous surface. In an embodiment, the marking instrument can be used to apply a mark to the non-porous surface of the marking element. In another embodiment, a mark applied on the non-porous surface using the marking instrument can be substantially removed without application of any solvent by wiping lightly with an erasing tool or by user's body part such as fingers or hands. In another embodiment, the mark on a non-porous surface can be wet-erased.

The non-porous surface of the marking element includes, but is not limited to, blackboard, whiteboard, a greenboard, a glass surface, a writing slate, a natural stone, a plastic surface, a coated surface, a metal surface, or a laminated surface. Suitable whiteboard surfaces generally include a melamine, vinyl, polyethylene laminate, or enamel resin layer affixed to a backing. Such whiteboards are characterized in that they have hard, white surfaces that are very smooth in appearance, and are essentially nonporous. Alternatively, a whiteboard may comprise a sheet of polymeric film such as an acrylic or UV curable resin.

In an embodiment, the kit further comprises an erasing tool. Any suitable erasing tool may be used including, but not limited to, a cloth, microfiber cloth, a felt eraser, a synthetic fiber eraser, or a sponge. In an embodiment, the marking may be erased by a user by wiping with fingers, hands, etc.

It is appreciated that certain features of the invention, which are for clarity described in the context of separate embodiments may also be provided in combination in a single embodiment. Conversely various features of the invention, which are for brevity, described in the context of a single embodiment, may also be provided separately or in any suitable sub-combination. Many other variations of the invention will be apparent to those skilled in the art and such variations are contemplated within the broad scope of the present invention.

Further aspects of the invention and preferred features thereof are given in the claims herein.

### EXAMPLES

The present invention will now be described in detail with reference to the following non-limiting examples provided to further illustrate the processes and compositions of the present invention. These examples are illustrative only and are not intended to limit the scope of the invention in any way. Unless otherwise specified all parts, percentages, and ratios are on a weight basis. The prefix C or COMP before an example indicates that it is comparative and does not form part of the invention.

Various registered trademarks, other designations and/or abbreviations are used herein to denote some of ingredients used to prepare the compositions of the invention. These are identified below by chemical name and/or trade name and optionally their manufacturer or supplier from whom they are available commercially. However where a chemical name and/or supplier of a material described herein is not given it may easily be found for example in reference literature well known to those skilled in the art.

In the examples herein when an example is described as repeated and/or prepared the same as another example described herein it is prepared analogously to the previous example using the same ingredients used in the same amounts in the same manner except where otherwise indicated.

Unless otherwise indicated, all compositional percentages and ratios recited herein are on a weight basis. The following ingredients are referred to in the Examples discussed further below.

### Materials

Euperlan OP White wax dispersion and Eumulgin VL 75 dispersant were purchased from BASF (Florham Park, NJ); Aquacer 581 carnauba wax dispersion was purchased from BYK USA (Wallingford, CT); Aquaslip 952 carnauba wax dispersion was purchased from Lubrizol Corporation (Piscataway, NJ); PVP K-15 dyeblocker (polyvinylpyrrolidone solution, 40 wt %) was purchased from Ashland (Columbus, OH); fluorescent pigment dispersions were purchased from Zhejiang Nano-Material Tech Co (Zhejiang, China); water-soluble dyes were purchased from Chromascape (Twinsburg, OH); Preventol CMK 40 was purchased from Lanxess Corporation (Pittsburgh, PA); Polyphjase AF-1 was purchased from Troy Corporation (Florham Park, NJ); and Reputain K50 was purchased from Arch Chemicals (Alpharetta, GA).

Examples of water and wax-based ink compositions of the present invention are as follows. These examples further illustrate the present invention but, of course, should not be construed as in any way limiting its scope. Quantities are in percent by weight of the total composition. These example compositions are suitable for use in marking on any non-porous surface.

### Example Nos. 1-12: Water and Wax-Based Ink Compositions

Different water and wax-based ink compositions were prepared using an opacifying waxy material, a dispersant, water and optional additives. These compositions were formulated in the form of marker inks. These water and wax-based ink compositions are set forth below in Table Nos. 1 and 2.

Water, opacifying wax dispersion (Euperlan OP White), and carnauba wax dispersion (Aquacer 581 or Aquaslip 952) were added to a suitable vessel equipped with a mixer with a Cowles blade. The vessel contents were mixed at 500 rpm initially, then the mixing speed was increased to 900 rpm after formation of a vortex. Mixing was continued for 5 minutes after which time dispersant (Eumulgin VL 75) was added and the vessel contents mixed for an additional 10 minutes. Optional PVP K15 dyeblocker may be added at this point if water-soluble dyes are used. Colorants (e.g., water soluble dyes and/or pigment dispersions) were added and mixing continued for an additional 15 minutes. Preservatives were added, and the contents were mixed for an additional 5 minutes.

TABLE No 1

| | Ex. 1 | Ex. 2 | Ex. 3 | Ex. 4 | Ex. 5 | Ex. 6 |
|---|---|---|---|---|---|---|
| | Red | Yellow | Orange | Golden Yellow | Green | Blue |
| Ingredients | Amounts in % by weight | | | | | |
| Water | 31.58 | 36.08 | 34.58 | 26.58 | 29.58 | 31.58 |
| Euperlan OP White | 40 | 40 | 40 | 40 | 40 | 40 |
| Aquacer 581 | 5 | 5 | 5 | 5 | 5 | 5 |
| FW-13 Fluorescent Red | 13 | — | 2.5 | 8 | — | — |
| FW-17 Fluorescent | — | 8.5 | — | 10 | 7.5 | — |
| Lemon Yellow | | | | | | |
| FW-15N Fluorescent | — | — | 7.5 | — | — | — |
| Orange | | | | | | |
| FW-19 Fluorescent Blue | — | — | — | — | 7.5 | 13 |
| FW-50 Fluorescent | — | — | — | — | — | — |
| Black | | | | | | |
| Eumulgin VL 75 | 10 | 10 | 10 | 10 | 10 | 10 |
| Preventol CMK 40 | 0.1 | 0.1 | 0.1 | 0.1 | 0.1 | 0.1 |
| Polyphase AF-1 | 0.15 | 0.15 | 0.15 | 0.15 | 0.15 | 0.15 |
| Reputain K50 | 0.17 | 0.17 | 0.17 | 0.17 | 0.17 | 0.17 |

TABLE No 2

| | Ex. 7 | Ex. 8 | Ex. 9 | Ex. 10 | Ex. 11 | Ex. 12 |
|---|---|---|---|---|---|---|
| | Blue | Yellow | Magenta | Green | Orange | Violet |
| Ingredients | Amounts in % by weight | | | | | |
| Water | 28.38 | 26.58 | 27.58 | 26.88 | 26.58 | 27.23 |
| Euperlan OP | 40 | 40 | 40 | 40 | 40 | 40 |
| White | | | | | | |
| Aquaslip 952 | 10 | 10 | 10 | 10 | 10 | 10 |
| Eumulgin VL 75 | 10 | 10 | 10 | 10 | 10 | 10 |
| PVP K-15 | 10 | 10 | 10 | 10 | 10 | 10 |
| Acid Red 52 | — | — | 2 | — | — | 2 |
| Acid Blue 9 | 1.2 | — | — | 0.7 | — | 0.35 |
| Acid Yellow 17 | — | 3 | — | 2 | — | — |
| FD&C Yellow 6 | — | — | — | — | 3 | — |
| Preventol | 0.1 | 0.1 | 0.1 | 0.1 | 0.1 | 0.1 |
| CMK 40 | | | | | | |
| Polyphase AF-1 | 0.15 | 0.15 | 0.15 | 0.15 | 0.15 | 0.15 |
| Reputain K50 | 0.17 | 0.17 | 0.17 | 0.17 | 0.17 | 0.17 |

Table No. 3 below summarizes the composition of the opacifying agent Euperlan OP White.

TABLE NO 3

| Euperlan OP White | Range |
|---|---|
| Ethylene glycol distearate | 25-28% |
| Sodium laureth sulfate | 9-11% |
| Cocamidopropyl betaine | 2-4% |
| Glyceryl oleate | 1-2% |
| Water | 56-60% |

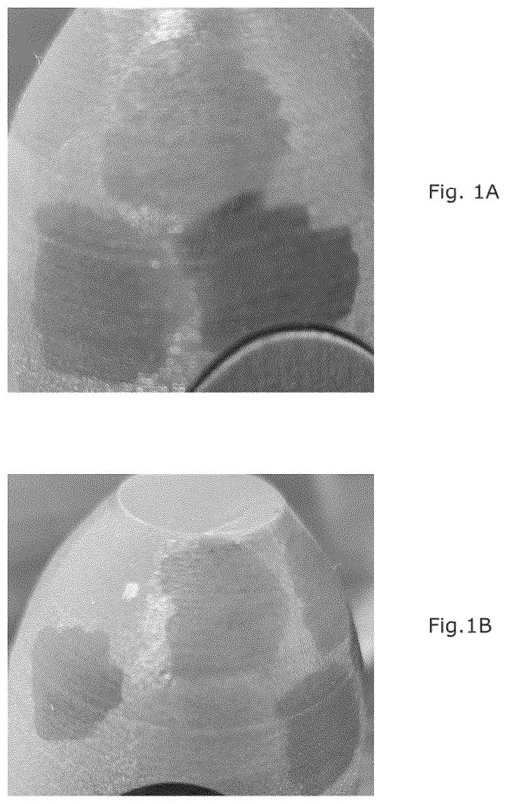

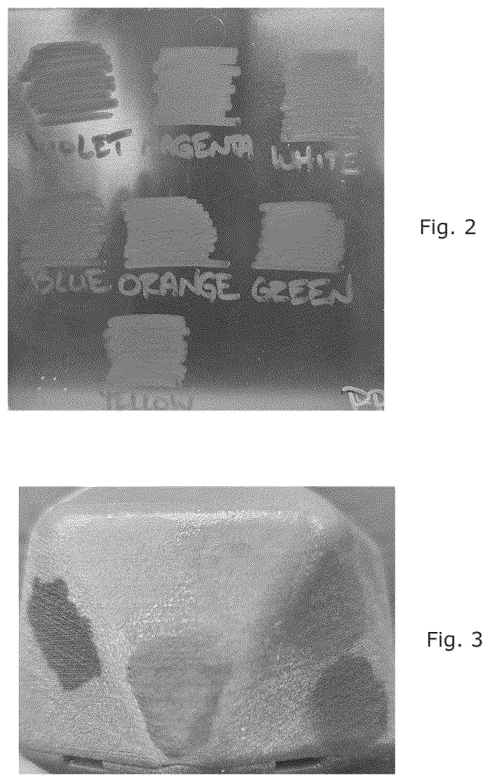

FIGS. 1A and 1B show markings by the ink compositions summarized in Table Nos. 1-2 on a gray polypropylene plastic surface. FIGS. 2 and 3 show markings by the ink compositions of Table Nos. 1-2 on a black polypropylene plastic surface and a green polypropylene plastic surface respectively.

Without wishing to be bound by any theory, it is believed that the opacifying wax present in the water and wax-based ink compositions create a film on the surface of nonporous surfaces, which appear as markings. It has been found that such markings can be removed with friction (microfiber cloth works best) and they can also be wet erased if need be.

In some embodiments, the water and wax-based ink composition is skin and fabric washable and substantially rub resistant. In particular, while not completely rub resistant, if artwork created using the water and wax-based ink composition is touched accidentally during play, it won't immediately rub off and requires friction to be removed completely.

Upon removal using friction, the water and wax-based ink leaves substantially no residue from the opacifier or any oils and is not flammable.

### Test Procedures

### Fabric Fugitivity

The fugitivity from fabric of the compositions of the invention was measured by the following test.

1. Pre-wash test fabrics with bleach, non-staining water softener and ordinary household phosphate detergent powder using 120° F. hot water as directed in ASTM D4265-83, and dry.

2. Cut test swatches of pre-washed fabrics to be tested.

3. Deposit marker inks onto fabric swatches and allow to dry for 4 hours.

4. Add a dummy load of unstained fabrics to provide a four pound wash load. Wash the load in a washing machine for 12 minutes with a warm (about 80° F. to 90° F.)/cold cycle or a cold (about 35° F. to 55° F.)/cold cycle.

5. Dry the load in a dryer.

6. Iron the test swatches and observe degree of staining.

### Evaluation of Test Data

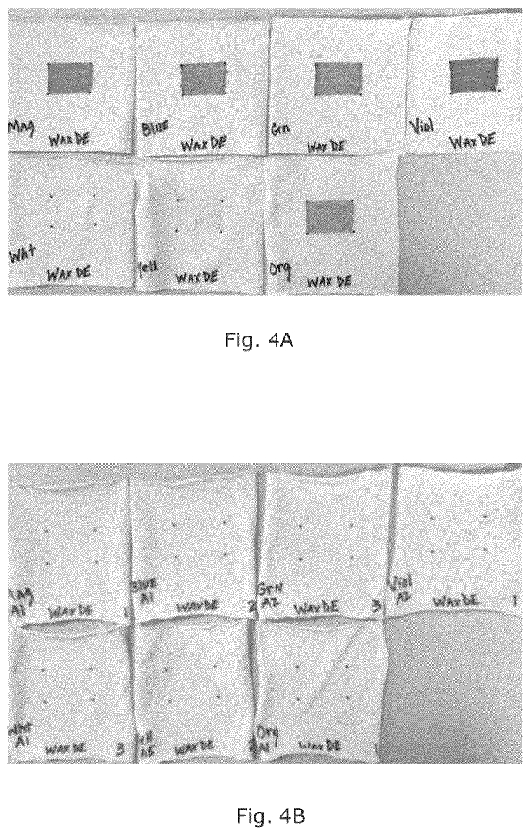

FIGS. 4A and 4B show the results of the washability of the water and wax-based inks summarized in Table 1. The washability was tested on 100% cotton fabric. Additionally, washability was examined using a washing machine with both a cold/cold cycle and a warm/cold cycle. The cold/cold cycle was repeated on the fabric samples. As demonstrated, no stains were observed on the 100% cotton samples after a second cold wash. For comparison, the fugitivity from fabric of a control coloring composition was analyzed. The control is a typical alcohol-based whiteboard ink composition.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

What is claimed:

1. A water and wax-based ink composition comprising:
a) an opacifying waxy material;
b) a dispersant; and
c) water.

2. The water and wax-based ink composition according to claim 1, wherein the opacifying waxy material comprises one or more of carnauba wax, beeswax, lanolin, tallow tree wax, laurel wax, bayberry wax, candelilla wax, ouricury wax, castor wax, Chinese wax, Japan wax, sugarcane wax, soy wax, paraffin waxes, microcrystalline waxes, synthetic waxes, polyethylene wax, montan wax, ceresin, ozocerite, monoglycerides, diglycerides, triglycerides, and esters of fatty alcohols and fatty acids having 12-40 carbon atoms.

3. The water and wax-based ink composition according to claim 1, wherein the opacifying waxy material is carnauba wax.

4. The water and wax-based ink composition according to claim 1, wherein the opacifying waxy material is a diester of alkylene glycol having 2-20 carbon atoms and a fatty acid comprising stearic acid, lauric acid, myristic acid, palmitic acid, arachidic acid, behenic acid, lignoceric acid, and cerotic acid.

5. The water and wax-based ink composition according to claim 1, further comprising a colorant.

6. The water and wax-based ink composition according to claim 5, wherein the colorant is a water-soluble dye.

7. The water and wax-based ink composition according to claim 6, wherein the water-soluble dye comprises an acid dye, a basic dye, a polymeric colorant, a fluorescent dye, a solvent dye, a disperse dye, a direct dye, a reactive dye, and an FD&C dye.

8. The water and wax-based ink composition according to claim 5, wherein the colorant is a pigment.

9. The water and wax-based ink composition according to claim 1, wherein the dispersant comprises one or more of alkylbenzene sulfonates, polyoxyethylene alkyl ethers, acetylenic diols, ethoxylated acetylenic diols, sultains, betaines, amine oxides, ethoxylated alcohols, nonylphenol ethoxylates, and cationic and anionic polymers.

10. The water and wax-based ink composition according to claim 1, further comprising one or more of a humectant, a surfactant, a preservative, a defoamer, and/or a pH regulant.

11. The water and wax-based ink composition of claim 1 comprising:
a) 5-50% by mass of the opacifying waxy material, wherein the opacifying waxy material comprises at least one of carnauba wax and ethylene glycol distearate;
b) 10-40% by mass of water;
c) an effective amount of dispersant; and
d) 0 to 15% of a water-soluble dye.

12. A marking instrument comprising the water and wax-based ink composition according to claim 1.

13. The marking instrument of claim 12, wherein the marking instrument is an erasable marker comprising a marker barrel and a writing tip, wherein the water and wax-based ink composition is disposed in the marker barrel.

14. The marking instrument according to claim 12, wherein the erasable marker is a dry-erase marker.

15. A kit comprising:
a marking element comprising a non-porous surface; and
a marking instrument according to claim 12,
wherein a mark applied on the non-porous surface using the marking instrument is substantially removable without application of any solvent.

16. The kit according to claim 15, wherein the non-porous surface comprises a blackboard, whiteboard, a greenboard, a glass surface, a writing slate, a natural stone, a plastic surface, a coated surface, a metal surface, or a laminated surface.

17. The kit according to claim 15, further comprising an erasing tool.

18. The kit according to claim 17, wherein the erasing tool comprises a fabric cloth, a microfiber cloth, a felt eraser, a synthetic fiber eraser, or a sponge.
